(19) United States
(12) Patent Application Publication
(10) Pub. No.: US 2009/0101183 A1
(43) Pub. Date: Apr. 23, 2009

(54) APPARATUS FOR CLEANING TUBE FINS OF AIR FAN COOLER FOR HEAT EXCHANGER

(75) Inventors: Young Cheol Kim, Ulsan (KR); Jae Sik Go, Ulsan (KR); Jae Hong Park, Ulsan (KR); Beong Ho Hong, Ulsan (KR); Wang Chun Lee, Ulsan (KR); Hyo Joon Kim, Ulsan (KR); Hyun Jin Yoon, Ulsan (KR)

Correspondence Address: DARBY & DARBY P.C., P.O. BOX 770, Church Street Station, New York, NY, 10008-0770, US

(73) Assignee: SK Energy Co., Ltd., Seoul (KR)

(21) Appl. No.: 12/254,313

(22) Filed: Oct. 20, 2008

(30) Foreign Application Priority Data
Oct. 22, 2007 (KR) 1020070106279

(51) Int. Cl. B08B 3/02

(52) U.S. Cl. 134/106

(57) ABSTRACT

Disclosed herein is an apparatus for cleaning tube fins of an air fan cooler for heat exchangers. The apparatus according to the present invention is constructed such that the tube fins can be cleaned in a mechanical manner even when the air fan cooler is in operation, thus preventing the heat exchange efficiency of the tube fins from becoming reduced by dust. Furthermore, the present invention restrains the use of chemicals, thus realizing environment-friendly cleaning.

### CROSS REFERENCE TO RELATED APPLICATION

This application claims the benefit of Korean Patent Application No. 10-2007-0106279, filed Oct. 22, 2007, entitled “AIR FAN COOLER TUBE FIN ONLINE CLEANING PACKAGE FOR HEAT EXCHANGER”, which is hereby incorporated by reference in its entirety into this application.

### BACKGROUND OF THE INVENTION

1. Field of the Invention

The present invention relates generally to apparatuses for cleaning tube fins of air fan coolers for heat exchangers and, more particularly, to an apparatus for cleaning tube fins of an air fan cooler for heat exchangers which is constructed such that the tube fins can be cleaned in a mechanical manner even when the air fan cooler is in operation, thus preventing the heat exchange efficiency of the tube fins from becoming reduced by dust, and cleaning of which restrains from the use of chemicals, thus realizing environment-friendly cleaning.

2. Description of the Related Art

Generally, tube fins of an air fan cooler for heat exchangers are provided by attaching thin fins to the surfaces of the tubes to increase heat exchange efficiency when heat of a tube side is transferred to air of a shell side. In other words, the tube fins function to increase the area available for heat exchange.

Tube fins are made of an aluminum having a thickness of about 0.4 mm. The tube fins surround the tubes.

Meanwhile, such tube fins become covered with a lot of dust while conducting heat exchange. The heat exchange efficiency of the tube fins may deteriorate due to the dust, with the result that the operation efficiency of the air fan cooler deteriorates, thus inducing a failure of the production of products.

In an effort to overcome these problems, techniques of dissolving dust using chemical reactions of chemicals have been used to remove dust from the tube fins. However, the operation of cleaning the tube fins using chemicals is disadvantageous in that only when the air fan cooler is not in operation can the cleaning operation be conducted.

In detail, if chemicals are applied to the tube fins when the air fan cooler is in operation, some of the chemicals may evaporate due to a relatively high temperature before the chemicals can act on the dust. Therefore, it is inefficient. In addition, the cleaning operation and a preparatory process therefor are very complex.

Moreover, in the case where chemicals are used for a long period of time, the tube fins made of aluminum may corrode, thus causing secondary damage. As well, there is a problem in that chemicals induce air and water pollution.

### SUMMARY OF THE INVENTION

The present invention has been made in an effort to provide an apparatus for cleaning tube fins of an air fan cooler for heat exchangers which can clean the tube fins even when the air fan cooler is in operation. In the cleaning process, the tube fins are prevented from becoming damaged, and environment-friendly cleaning can be conducted.

The present invention provides an apparatus for cleaning tube fins of an air fan cooler for heat exchangers which is constructed such that the cleaning operation of removing dust from the tube fins can be conducted even when the air fan cooler is in operation, thus preventing the heat exchange efficiency of the tube fins from becoming reduced by dust.

Furthermore, the present invention provides an apparatus for cleaning tube fins of an air fan cooler for heat exchangers which can prevent the tube fins from becoming partially damaged or corroded during the process of removing dust from the tube fins.

In addition, the present invention provides an apparatus for cleaning tube fins of an air fan cooler for heat exchangers which restrains from the use of chemicals, thus allowing environment-friendly cleaning.

In an apparatus for cleaning tube fins of an air fan cooler for heat exchangers according to the present invention, a condensate generator generates condensate using heat exchange between steam and cooling water. A feed pipe is connected to the condensate generator to transfer steam containing the condensate. An on/off valve is provided at a predetermined position on the feed pipe to control the transfer of the steam containing the condensate. A jet nozzle is provided on a front end of the feed pipe to jet the steam containing the condensate when the on/off valve is turned on. A support unit is coupled to the feed pipe and is hung on the air fan cooler to fasten the feed pipe to the air fan cooler.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded perspective view illustrating an embodiment of an air fan cooler for a heat exchanger according to the present invention;

FIG. 2 is a schematic view illustrating an embodiment of a cleaning apparatus according to the present invention;

FIG. 3 is a schematic view illustrating an embodiment of a condensate generator according to the present invention;

FIGS. 4 through 6 are enlarged views illustrating several embodiments of a jet nozzle according to the present invention; and

FIG. 7 is an enlarged view illustrating an embodiment of a support unit and the use thereof according to the present invention.

### DESCRIPTION OF THE PREFERRED EMBODIMENTS

Hereinafter, an embodiment of the present invention will be described in detail with reference to the attached drawings.

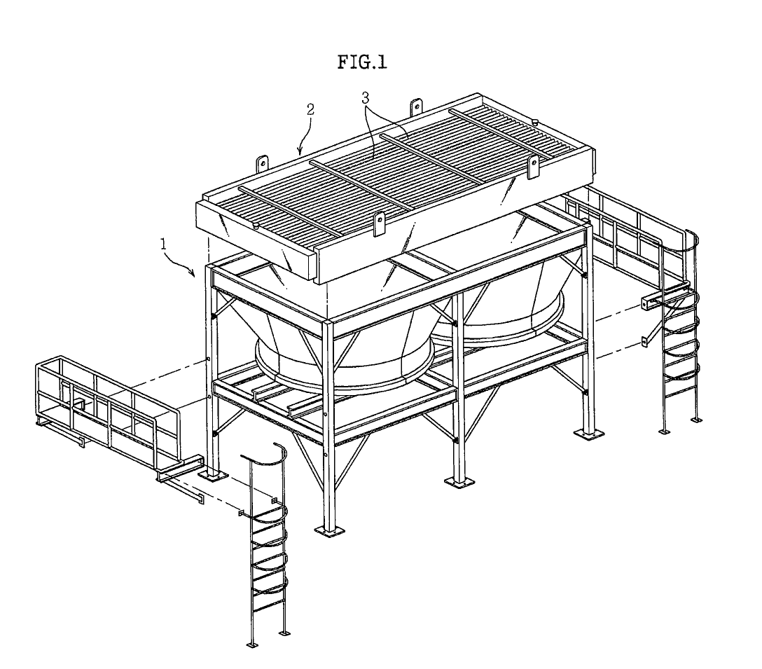

FIG. 1 is an exploded perspective view illustrating an embodiment of an air fan cooler for heat exchangers according to the present invention, in which tubes having fins are installed on the air fan cooler.

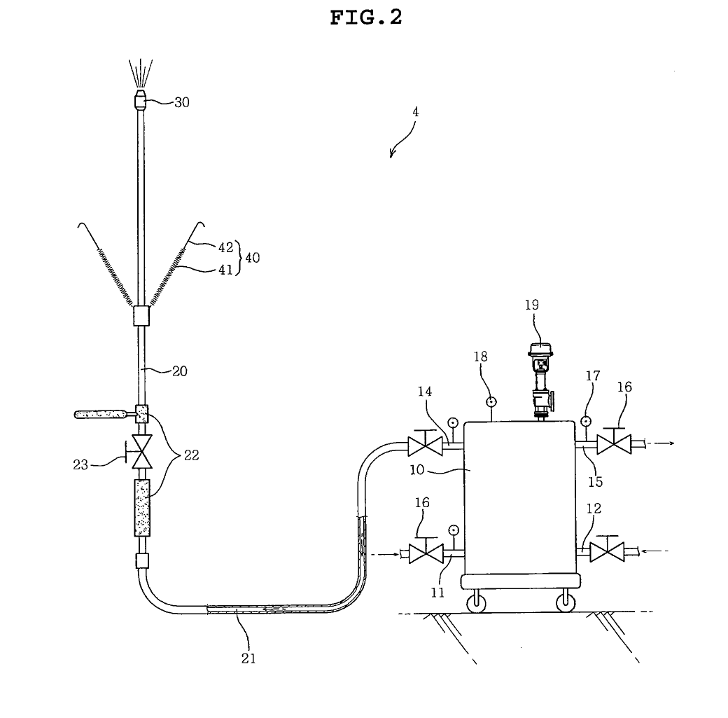

FIG. 2 is a schematic view of an embodiment of a cleaning apparatus according to the present invention to illustrate the construction and connection of the cleaning apparatus, which jets steam containing condensate onto the tube fins of the air fan cooler to remove dust from the tube fins.

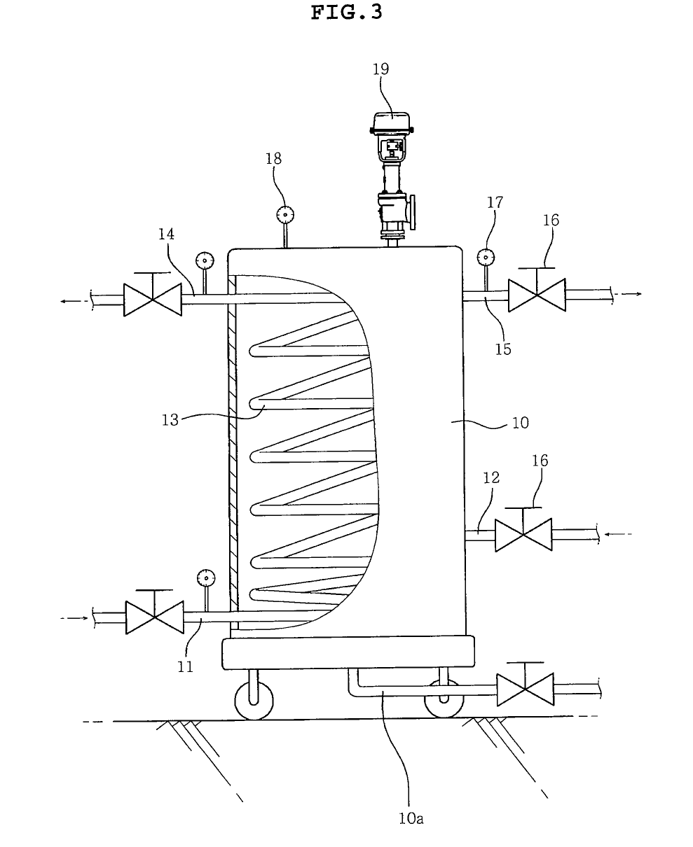

FIG. 3 is a schematic view illustrating an embodiment of a condensate generator according to the present invention. In detail, FIG. 3 schematically shows the condensate generator, which generates condensate using heat exchange between steam and cooling water, and to which a thermometer for measuring temperatures of the supplied steam and cooling water, and a pressure gauges and safety valves for measuring and controlling internal pressure are mounted.

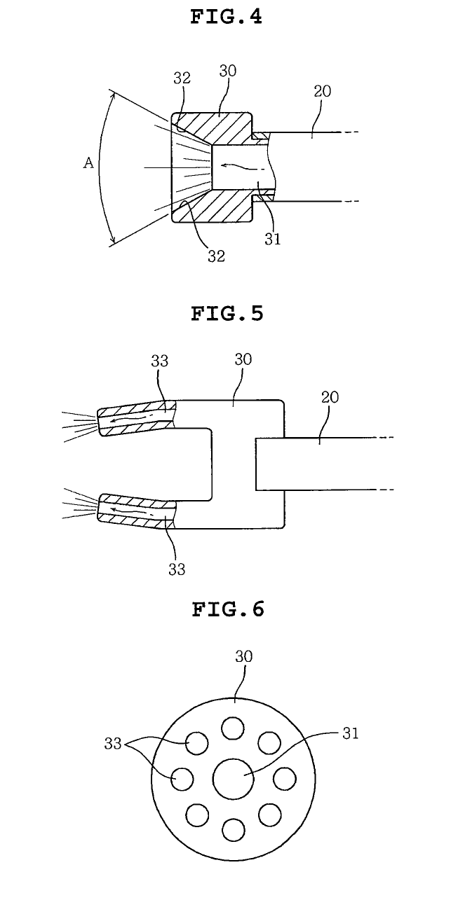

FIGS. 4 through 6 are enlarged views illustrating several embodiments of a jet nozzle according to the present invention. Depending on the structure of the tube fins, the jet nozzle may have various structures, for example, such that steam containing condensate is jetted in a spray manner or in several directions.

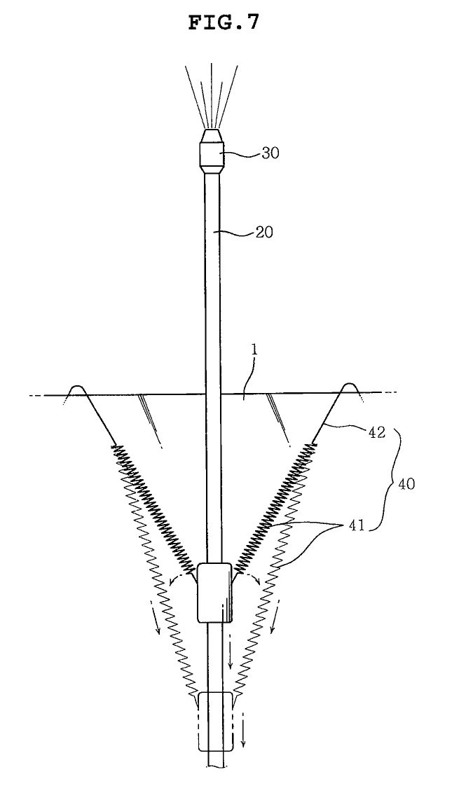

FIG. 7 is an enlarged view illustrating an embodiment of a support unit and the use thereof according to the present invention, in which tension springs are coupled to a feed pipe and have hooks on the ends thereof such that the cleaning apparatus is hung on the air fan cooler.

In detail, as shown in FIG. 1, the present invention is constructed such that the tube fins, which serve to increase the surface area for heat exchange of the air fan cooler 1, can be cleaned even when the air fan cooler 1 is in operation. Thus, the present invention prevents a reduction in heat exchange efficiency of the tubes 2 and a reduction in operational efficiency of the air fan cooler 1.

To achieve the above purposes, as shown in FIG. 2, the cleaning apparatus 4 according to the present invention includes the condensate generator 10, which generates condensate, the feed pipe 20, which moves steam containing condensate, an on/off valve 23, which controls the feed pipe 20, a jet nozzle 30, and a support unit 40, which fastens the feed pipe 20 to the air fan cooler 1.

The condensate generator 10 generates condensate using heat exchange between steam and cooling water. In an embodiment of this, as shown in FIGS. 2 and 3, a steam supply pipe 11 is connected to the condensate generator 10 to supply steam to the condensate generator 10. A cooling water supply pipe 12 is connected to the condensate generator 10 to supply cooling water, which absorbs heat from steam supplied from the steam supply pipe 11, to the condensate generator 10.

Furthermore, a steam discharge pipe 14 is mounted to the condensate generator 10. The steam discharge pipe 14 is connected to the steam supply pipe 11 through a heat exchange coil 13 to discharge steam containing condensate, which is condensed by heat exchange with cooling water. A cooling water discharge pipe 15 is mounted to the condensate generator 10 at a position opposite the steam discharge pipe 14 to discharge cooling water, which absorbs heat from steam.

In an embodiment, the turning on/off operation of each of the above-mentioned pipes is controlled by a control valve 16. Preferably, a check valve may be used as each control valve 16 to prevent steam or cooling water from flowing backwards.

In such construction of the condensate generator 10, steam is supplied into the condensate generator 10 through the steam supply pipe 11. While the supplied steam flows along the heat exchange coil 13, the steam is condensed by giving heat to cooling water supplied through the cooling water supply pipe 12, thereby generating condensate. Thereafter, the steam containing condensate therein is discharged outside the condensate generator 10 through the steam discharge pipe 14.

Therefore, steam and cooling water must be supplied to the condensate generator 10 at temperatures appropriate for heat exchange between them. In addition, the heat exchange coil 13, in which steam is substantially condensed, must have a length appropriate to generate condensate. For this, the following calculation formulas are proposed.

[Calculation Formulas]

Steam: pressure 10.5 Kg/cm², temperature 185° C.

Cooling water: temperature 20° C.,

1. latent heat of vaporization of steam: 1,993 KJ/Kg (=476.6 Kcal/kg) 2. flow rate of steam in pipe of ¾″

(under conditions of 10 kg/cm² and 40 m/s) 216 kg/hr

3. demand rate of condensed steam (on the basis of condensate of 95%)

216 kg/hr×0.95=205.2 kg/hr

4. heat capacity of steam of 205.2 kg/hr

205.2 kg/hr×1,993 KJ/Kg=408.96 4KJ/hr

5. injection rate of cooling water: primary supply temperature 20° C., secondary discharge temperature 80° C., ΔT 60,

408.964 KJ/hr÷(4.19 kJ/Kg.° C.×60° C.)=1.627 kg/hr=27 [symbol] /min

6. internal area of heat exchange coil (A)

ΔTAM=185° C.−((20+80)/2)=135° C.

408.964 KJ/hr=7,200 KJ/hr×A×135° C.

A=0.421 m²(1+0.1)=0.463 m²

0.463 m²÷0.085 m²/m=5.45 m

Here, to easily comprehend whether steam and cooling water are supplied in response to the above calculation formulas, a thermometer 17 is provided on each of the pipes connected to the condensate generator 10 to measure a supply or discharge temperature of steam or cooling water, and a pressure gauges 18, which measures the pressure in the condensate generator 10, and a safety valve 19, which controls the internal pressure, are provided on the condensate generator 10.

Therefore, whether steam and/or cooling water are supplied into the condensate generator 10 in response to the above calculation formulas can be precisely monitored using the thermometer 17. As well, the pressure in the condensate generator 10 can be monitored and controlled by the pressure gauges 18 and the safety valve 19, ensuring that a process of generating condensate can be safely performed.

In the case where a drain pipe 10a is connected to the condensate generator 10, dew, which forms on the inner surface of the condensate generator 10 in the process of heat exchange between steam and cooling water, can be used as condensate.

The feed pipe 20 according to the present invention is connected to the condensate generator 10 and thus serves to transfer steam containing condensate. In an embodiment, the feed pipe 20 is connected to the condensate generator 10 through a flexible hose 21, so that the feed pipe 20 can be freely moved.

In detail, the feed pipe 20 is a hollow pipe to transfer steam discharged from the condensate generator 10. The feed pipe 20 is connected to the steam discharge pipe 14 by the flexible hose 21 and thus transfers steam, which contains condensate and is supplied from the condensate generator 10 via the flexible pipe 21.

Here, the junction between the feed pipe 20 and the flexible hose 21 is sealed to prevent water leakage during a process of supplying and transferring steam.

The material for the feed pipe 20 is not limited to a special material, but because the main function of the feed pipe 20 is to transfer steam containing condensate, it is preferable that the feed pipe 20 be made of stainless steel (SUS), which is relatively light and does not easily corrode and thus can be used for a long period of time.

Furthermore, a handle 22, which is made of rubber or synthetic resin, is attached to the feed pipe 20. Thus, the feed pipe 20 is prevented from undesirably slipping from the hands of a user when the user moves the feed pipe 20 or removes dust from tube fins 3 of the tubes 2. In addition, even if an external impact is applied to the feed pipe 20, the handle 22 can absorb the impact and thus protect the feed pipe 20.

The on/off valve 23 is provided at a predetermined position on the feed pipe 20 to turn on/off the feed pipe 20, thus controlling the supply of steam.

It is preferable that the on/off valve 23 be disposed at a position adjacent to the handle 22 such that the user holds the handle 22 using his/her one hand and conveniently controls the on/off valve 23 using the other hand.

A jet nozzle 30 is provided on the front end of the feed pipe 20, which is turned on or off by controlling the on/off valve 23. When the on/off valve 23 is turned on, the jet nozzle 30 jets steam, containing condensate, onto the fins 3 of the tubes 2 to remove dust from the fins 3.

The jet nozzle 30, which is mounted to the front end of the feed pipe 20, has a jet hole 31, through which steam containing condensate is jetted outwards. It is preferable that the jet nozzle 30 have a jet structure corresponding to the structure of the fins 3 of the tubes 2.

In one embodiment of the jet nozzle 30, as depicted in FIG. 4, the jet nozzle 30 may have a jet diffusion portion 32, which is inclinedly formed with respect to the jet nozzle 30 to diffuse a steam jet. The suitable inclination angle of the jet diffusion portion 32 is about 60°.

In this case, when steam containing condensate is jetted outwards through the jet hole 31 formed in the jet nozzle 30, the steam is diffused by the jet diffusion portion 32, thus effectively removing dust from the fins 3 of the tubes 2.

Alternatively, the jet nozzle 30 according to the present invention may have a structure such that jets of steam are jetted in several directions, as stated above. Embodiments of such a multidirectional jet structure are shown in FIGS. 5 and 6. As shown in these drawings, a pair of subsidiary jet holes 33 may be formed in the jet nozzle 30, and several subsidiary jet holes 33 may be arranged around the main jet hole 31 in a circumferential direction.

As such, the jet nozzle 30 may have various jet structures to jet steam in a manner suitable for the structure of the fins 3 of the tubes 2. In the case where steam discharged from the jet hole 31 is jetted in multiple directions through the two subsidiary jet holes 33 or the circumferentially arranged jet holes 33, dust can be more effectively removed from the fins of the tubes 2.

Meanwhile, the support unit 40 is connected to the feed pipe 20 such that the feed pipe 20, having the jet nozzle 30 on the front end thereof, is hung and supported on the air fan cooler 1 by the support unit 40. Typically, a string or a cord is used as the support unit 40. Because of this installation of the support unit 40, fatigue of the user attributable to conducting the cleaning operation for a long time can be reduced.

As shown in FIG. 7, preferably, tension springs 41 may be coupled to the feed pipe 20 to absorb the weight of the cleaning apparatus 4 and the reaction force generated when steam is jetted. A hook 42 is provided on the end of each tension spring 41.

As such, in the case where the support unit 40 comprises the tension springs 41, each of which has the hook 42 for hanging the tension spring 41 on the air fan cooler 1, the weight of the cleaning apparatus 4 and the reaction force, generated when steam is jetted to remove dust, can be absorbed by the support unit 40.

Therefore, in the present invention, because the feed pipe 20 is provided with the support unit 40, the operation of removing dust from the fins 3 of the tubes 2 can be easily and conveniently conducted.

The operation of the cleaning apparatus 4 according to the present invention and the process of removing dust from the fins 3 of the tubes 2 of the air fan cooler 1 will be explained in detail below.

To clean the fins 3 of the tubes 2 of the air fan cooler 1, steam and cooling water are first supplied into the condensate generator 10 through the steam supply pipe 11 and the cooling water supply pipe 12, respectively. Then, condensate is generated in the condensate generator 10 by heat exchange between steam and cooling water. Steam containing generated condensate is supplied into the flexible hose 21 through the steam discharge pipe 14. The cooling water is discharged to outside of the condensate generator 10 through the cooling water discharge pipe 15 and then is reused.

The steam supplied into the flexible hose 21 is fed into the feed pipe 20. When the on/off valve 23 is turned on, the steam is discharged to the fins 3 of the tubes 2 of the air fan cooler 1 through the jet nozzle 30 to remove dust therefrom.

In this process, the jet nozzle 30 diffuses and jets steam using the jet diffusion portion 32 or jets steam in multiple directions using the subsidiary jet holes 33, thus blowing and removing dust from the fins 3 of the tubes 2.

Here, the cleaning apparatus 4 is supported by the air fan cooler 1 using the support unit 40, so that the user can easily control the direction of the feed pipe 20 using the handle 22. Hence, even if the operation of removing dust from the fins 3 of the tubes 2 is conducted for a long time, the user can conveniently perform the cleaning operation without feeling fatigue.

As described above, in a cleaning apparatus according to the present invention, because the operation of removing dust from tube fins of an air fan cooler to prevent a reduction of the operation efficiency of the air fan cooler due to dust is conducted in a mechanical manner, even when the air fan cooler is in operation can the cleaning operation be conducted. Therefore, the operation of a heat exchanger can be efficiently and continuously conducted, thus increasing the productivity.

Furthermore, because the present invention removes dust from the tube fins by jetting steam containing condensate and not by using a chemical reaction, the tube fins are prevented from becoming partially damaged or corroded. In addition, the cleaning apparatus is provided with a support unit, so that even if the cleaning operation is performed for a long time, fatigue of a user can be markedly reduced.

Therefore, the present invention restrains from the use of chemicals, which have been used to remove dust from the tube fins, thus reducing air and water pollution. As a result, the present invention can realize the environment-friendly cleaning operation.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for cleaning tube fins of an air fan cooler for heat exchangers, comprising:
a condensate generator to generate condensate using heat exchange between steam and cooling water;
a feed pipe connected to the condensate generator to transfer steam containing the condensate;
an on/off valve provided at a predetermined position on the feed pipe to control the transfer of the steam containing the condensate;
a jet nozzle provided on a front end of the feed pipe to jet the steam containing the condensate when the on/off valve is turned on; and
a support unit coupled to the feed pipe and hung on the air fan cooler to fasten the feed pipe to the air fan cooler.

2. The apparatus as set forth in claim 1, a thermometers to measure supply and discharge temperatures of the steam and the cooling water, pressure gauges to measure supply and discharge pressures of the steam and the cooling water, and a safety valve to prevent a pressure in the condensate generator from increasing beyond a normal value is provided on the condensate generator.

3. The apparatus as set forth in claim 1, wherein the jet nozzle has a jet diffusion portion, which is inclinedly formed with respect to the jet nozzle to diffuse a jet of the steam containing condensate.

4. The apparatus as set forth in claim 1, wherein the jet nozzle has at least one a subsidiary jet hole to jet the steam containing condensate in multiple directions.

5. The apparatus as set forth in claim 1, wherein the support unit comprises a tension spring coupled to the feed pipe, with a hook provided on an end of the tension spring.
